(19) United States
(12) Patent Application Publication
(10) Pub. No.: US 2015/0354205 A1
(43) Pub. Date: Dec. 10, 2015

(54) VARIABLE-HUMIDITY DIRECTIONAL VAPOUR BARRIER

(71) Applicant: SILU VERWALTUNG AG, Meggen (CH)

(72) Inventors: Marco Sieber, Horw (CH); Reto Sieber, Luzern (CH)

(21) Appl. No.: 14/763,571

(22) PCT Filed: Jan. 29, 2014
(86) PCT No.: PCT/EP2014/051732

§ 371 Date: Jul. 27, 2015

(30) Foreign Application Priority Data
Jan. 29, 2013 (EP) 13153018.0

(51) Int. Cl. E04B 1/66; B32B 27/08; B32B 27/34; C08J 5/18

(52) U.S. Cl. CPC E04B 1/665; C08J 5/18; B32B 27/08; B32B 27/34; C08J 2377/06; C08J 2331/04; C08J 2371/00; B32B 2307/7246; B32B 2419/00

(57) ABSTRACT

The present invention relates to a variable-humidity directional vapour barrier which comprises at least two layers, wherein one layer (layer 1) is humidity-variable and the other layer (layer 2) is humidity-independent. For layer 1, the quotient for the water vapour diffusion resistance from the s_{d} value at 25% mean relative air humidity to the s_{d} value at 71.5% mean relative air humidity is greater than 3. For layer 2, the quotient for the water vapour diffusion resistance from the s_{d} value at 25% mean relative air humidity to the s_{d} value at 71.5% mean relative air humidity is less than 1.5. Furthermore, the invention relates to the use of the vapour barrier for sealing buildings and to a system which comprises said vapour barrier. Furthermore, the invention relates to the use of a certain film for sealing a space in buildings which is closed by an exterior skin, wherein the film comprises defined film sides X and Y or layers 1 and 2 and is arranged in a certain way.

The present invention relates to a humidity-variable directional vapor barrier, its use for the sealing of buildings as well as a system comprising this vapor barrier. The invention relates also to the use of a film for sealing a space in buildings which is closed by an outer skin.

Vapor barriers are usually used in roof structures of buildings in order to control the diffusion of water vapor into the structure. They are designed to prevent the penetration of humidity into insulating layers, but allow at the same time the drying of a building. A vapor barrier also has the function of preventing the penetration of humidity into the supporting structure from wood or metal, for example.

A measure for the resistance which a layer of structural components opposes to water vapor diffusion is the s_{d} value, which is defined as a water vapor diffusion equivalent of the thickness of an air layer and constitutes the product from the figure of the water vapor resistance and the thickness of the layer. The higher the s_{d} value is, the larger the resistance is. An s_{d} value of 2 m means that the layer of the water vapor diffusion opposes an identical resistance like an air layer which is 2 m thick. Accordingly, an sa value of 10 m means that the resistance of the layer corresponds to an air layer which is 10 m thick. Water vapor diffusion through a layer having an s_{d} value of 10 m is thus slower than in case of a layer having an s_{d} value of 2 M.

Different vapor barriers are known from the prior art. DE 101 11 319 A1 relates to a vapor barrier from a material which has an s_{d} value depending on ambient humidity, in such a way that at a relative humidity in the range of 20 to 60% or of 30% to 50%, the sa value is 5-10 m and at a relative humidity in the range of 50 to 95%, the s_{d} value is <2 m or <1 m. The material may be polyethylene or polypropylene which contains acrylic acid as a polar component. From EP 1 372 956 B₁, the use of ionomeres in vapor barriers is known. DE 198 57 483 A1 describes three-layered sarking membranes, where the central layer is formed as an adhesive layer and has an s_{d} value depending on the ambient humidity. DE 199 02 102 A1 relates to a composite material made of at least three layers which, in addition to the air sealing function, has the task of retaining harmful or toxic substances.

DE 199 44 819 A1 discloses vapor barriers where a thin film is applied to a non-woven fabric and where the water vapor permeability is greater from the side of the film than from the side of the non-woven fabric.

From utility model AT 009 694 U2, a vapor barrier is known whose water vapor diffusion resistance is direction-dependent and comprises at least three layers, of which two are outer layers blocking water vapor and a humidity-storing layer in the middle.

EP 0 821 755 A1 discloses a vapor barrier whose water vapor diffusion resistance depends on ambient humidity, in such a way that at a relative ambient humidity of 30% to 50%, the s_{d} value is of 2-5 m and at a relative ambient humidity of 60% to 870%, the s_{d} value is <than 1 m. Thus, in summer, when the ambient humidity, as a rule, is higher, the diffusion resistance is supposed to be lesser in order to promote the drying of the insulation, whereas in winter, when there is, as a rule, less humidity, the diffusion resistance is greater. As a humidity-variable material, polyamide is disclosed.

With vapor barriers from polyamide, there is the problem that in spaces with high humidity, like bathroom or kitchen, there is a high water vapor diffusion also in winter, which may lead to the condensation of water in the roof insulation and/or in the insulation of outer walls and thus to structural damage. Likewise, a condensation of water may occur in the roof structure.

It was the objective of the present invention to eliminate this problem while maintaining the desired properties of a vapor barrier.

For the solution of this problem, a vapor barrier comprises at least two layers is proposed, of which one layer is humidity-variable and the other layer essentially is not humidity-variable.

Furthermore, the use of a direction-sensitive film with layers of a different humidity variability for the sealing of building constructions is proposed.

Thus, the invention relates to a vapor barrier comprising at least two layers, wherein one layer (layer 1) is humidity-variable and the quotient from the water vapor diffusion resistance of the s_{d} value is, at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is greater than 3, and the other layer (layer 2) is essentially humidity-independent, preferably humidity-independent, and the quotient from the s_{d} value at 25% of mean relative air humidity (according to DIN EN ISO 12575:2001 condition A/Wet Cup) to the s_{d} value at 71.5% of mean relative air humidity (according to DIN EN ISO 12575:2001 condition C/Wet Cup) is less than 1.5. Preferably, the two layers together (layer 1 and layer 2) have a thickness of 20 to 550 μm. If there are further layers, the overall thickness of the vapor barrier preferably does not exceed 700 μm.

In addition, the invention relates to the use of the vapor barrier for the sealing of building envelopes as well as a system comprising the vapor barrier and a component or material which, in the construction sector, is to be sealed in the building envelope.

Furthermore, the invention concerns the use of a film for sealing a space closed by an outer skin in buildings, wherein the film has a film side X and an opposite film side Y and the film is arranged such that film side X is aligned with the outer skin, wherein film sides X and Y are defined such that the water vapor diffusion from film side X to film side Y is greater than the water vapor diffusion from film side Y to film side X, with the proviso that in the experimental setup according to DIN EN ISO 12572:2001 condition B (85% RH to 0% RH; 23° C.), film side X faces the side of higher relative air humidity, whereby a greater water vapor diffusion can be measured than when at the same measurement, film side Y faces the side of the higher relative air humidity.

Furthermore, the invention concerns the use of a film for sealing a space closed by an outer skin in buildings, wherein the film comprises at least two layers, wherein one layer (layer 1) is humidity-variable and the quotient from water vapor diffusion resistance from the s_{d} value of this single layer at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is greater than 3, and the other layer (layer 2) is essentially humidity-invariable and the quotient from the s_{d} value of this single layer at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is less than 1.5, wherein the film is arranged such that layer 1 is aligned with the outer skin.

In a preferred embodiment, layer 1 of the film is aligned with film side X, or the outer side of layer 1 forms film side X. In a further preferred embodiment, the film is arranged within the closed space. In another preferred embodiment, the film is arranged outside of the closed space. In a preferred embodiment of the invention, the film is a vapor barrier. In another preferred embodiment of the invention, the outer skin is formed by wall structures, floor structures and/or ceiling structures in buildings.

In addition, the invention relates to a method for sealing a space in buildings which is closed by an outer skin by use of a film, as well as a system comprising the film and the outer skin.

Preferred embodiments and configurations of the invention are defined in the following description, claims and figures.

The figures show:

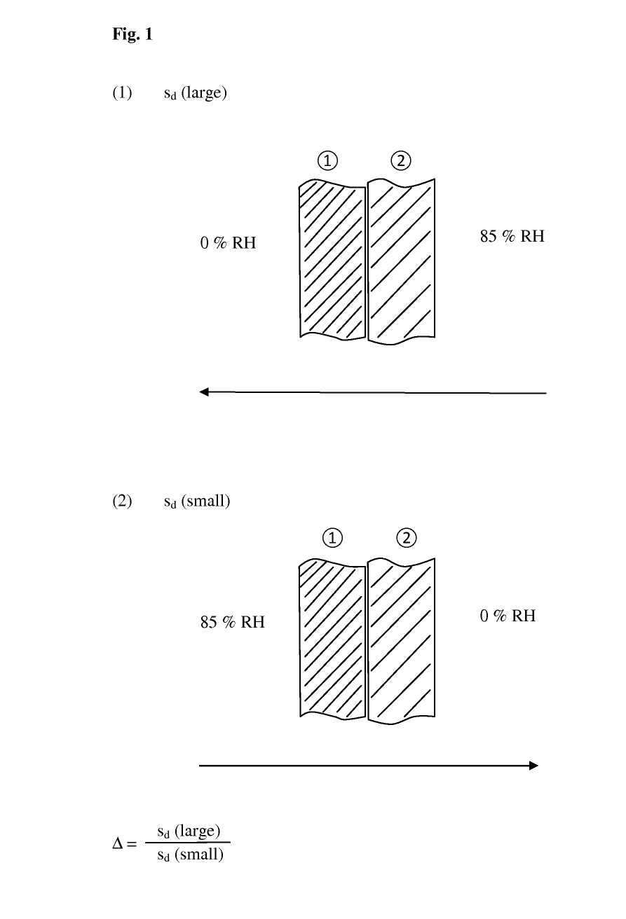

FIG. 1 shows an experimental setup for measuring the directional sensitivity of a vapor barrier;

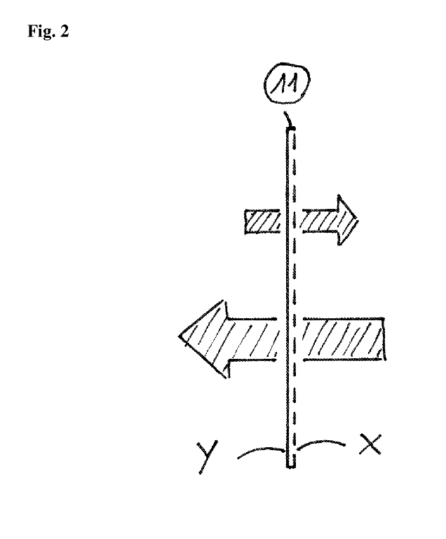

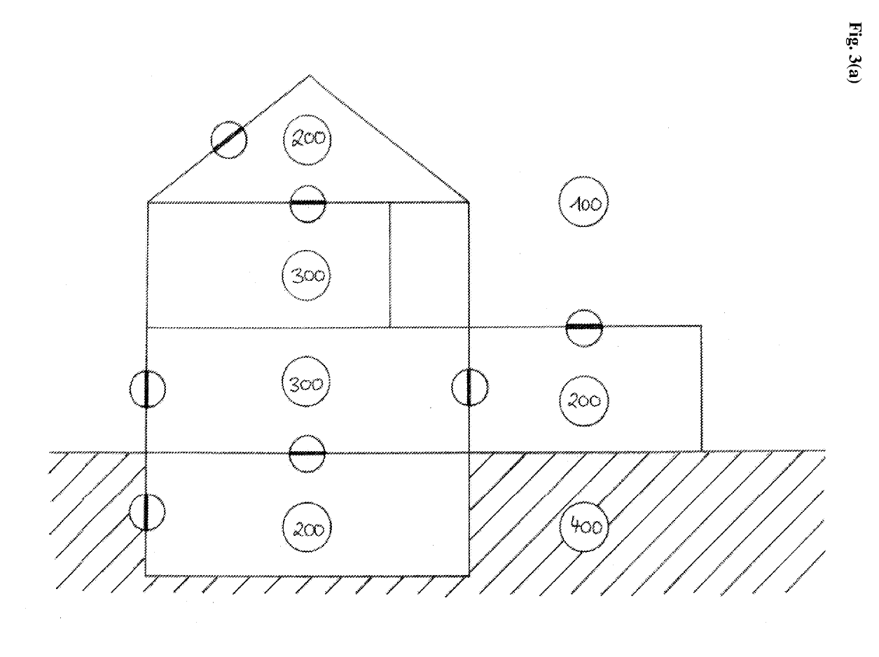

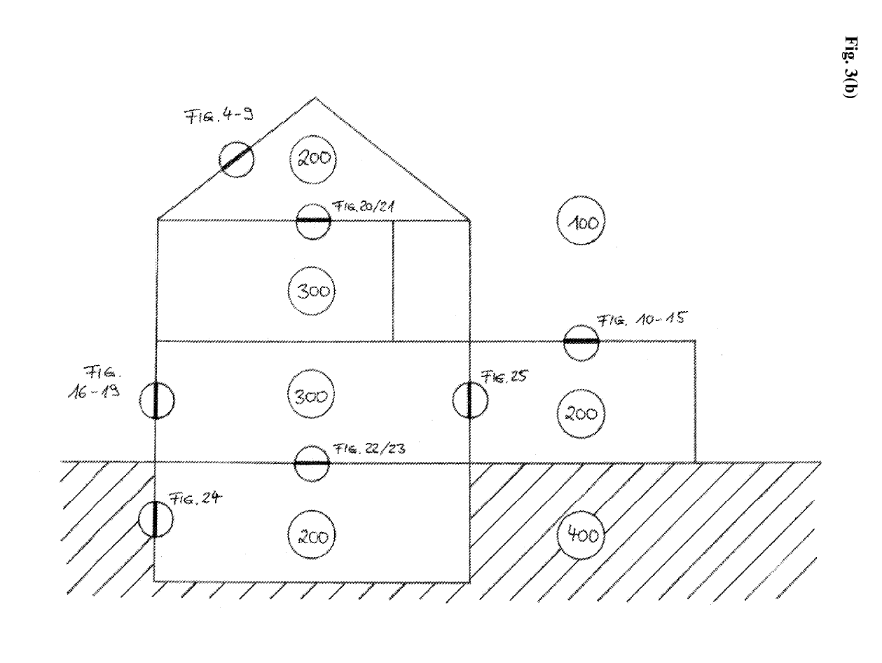

FIG. 2 shows the operating principle of a film used according to the invention with film sides X and Y;

FIG. 3(a) schematically shows a house as an outer skin with mounting options for the film;

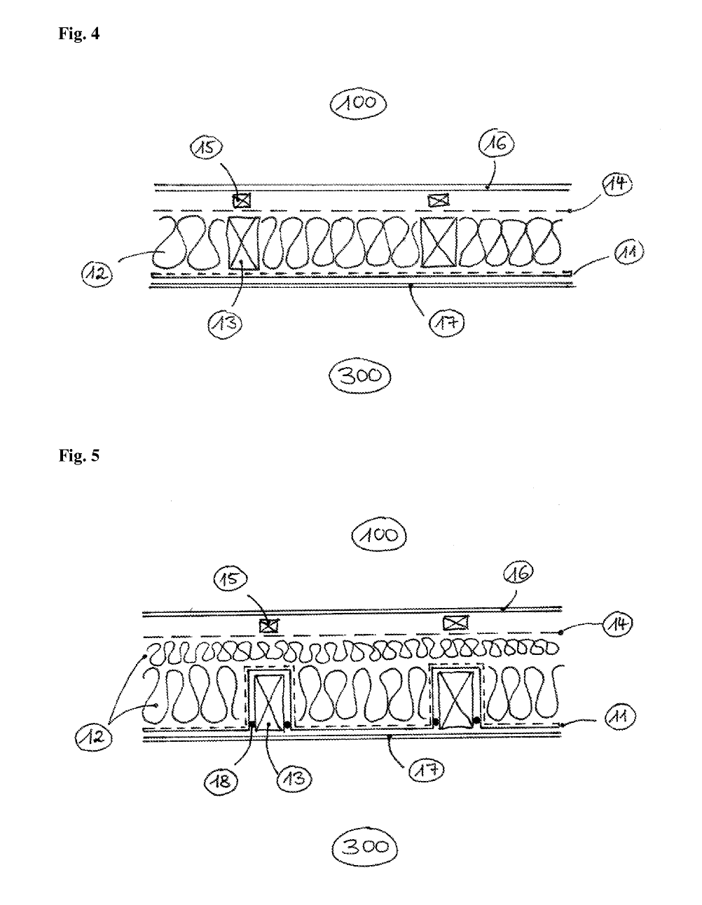

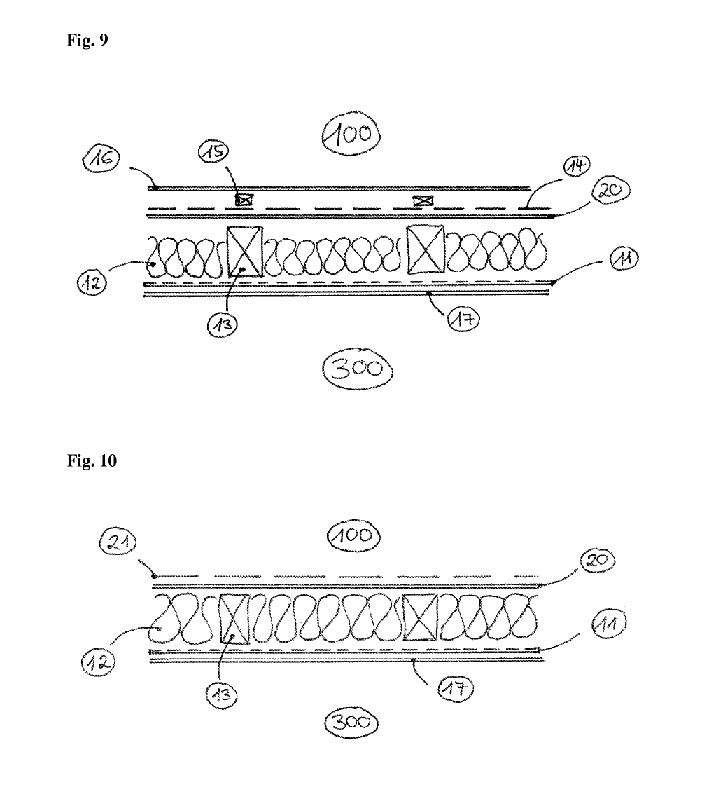

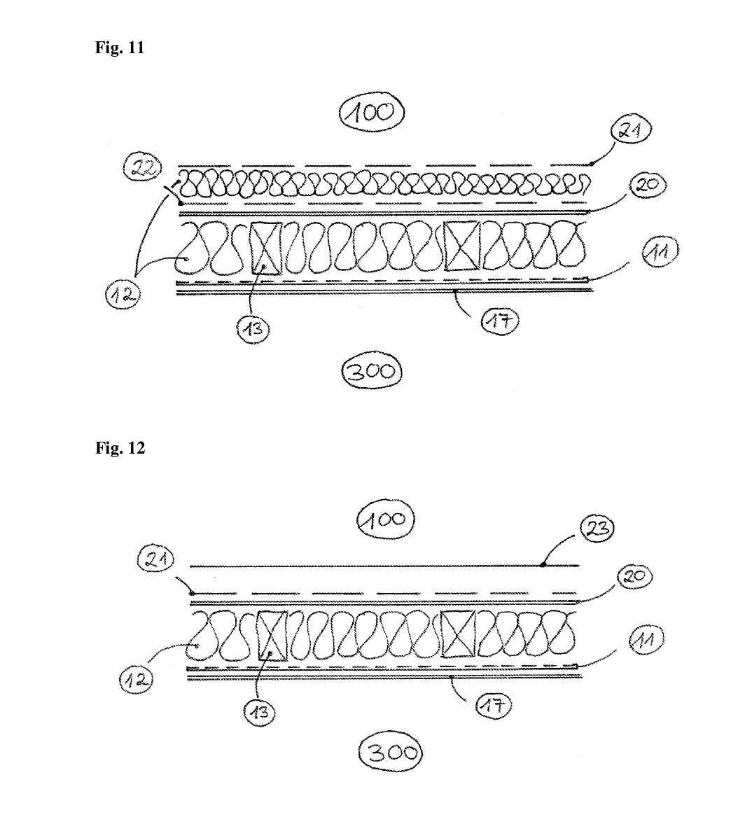

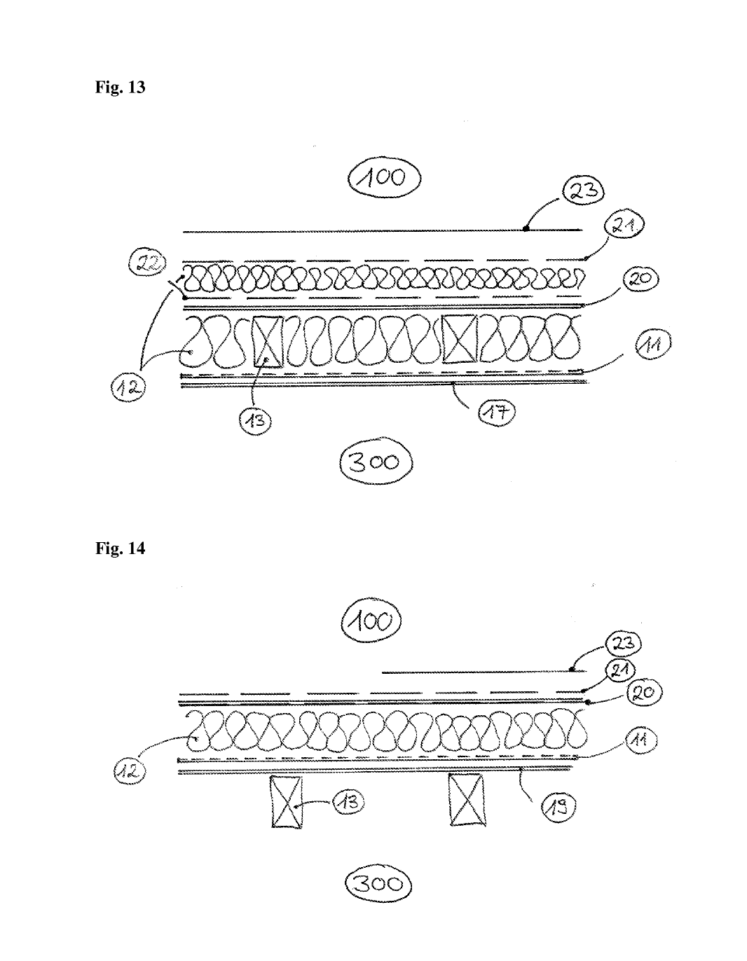

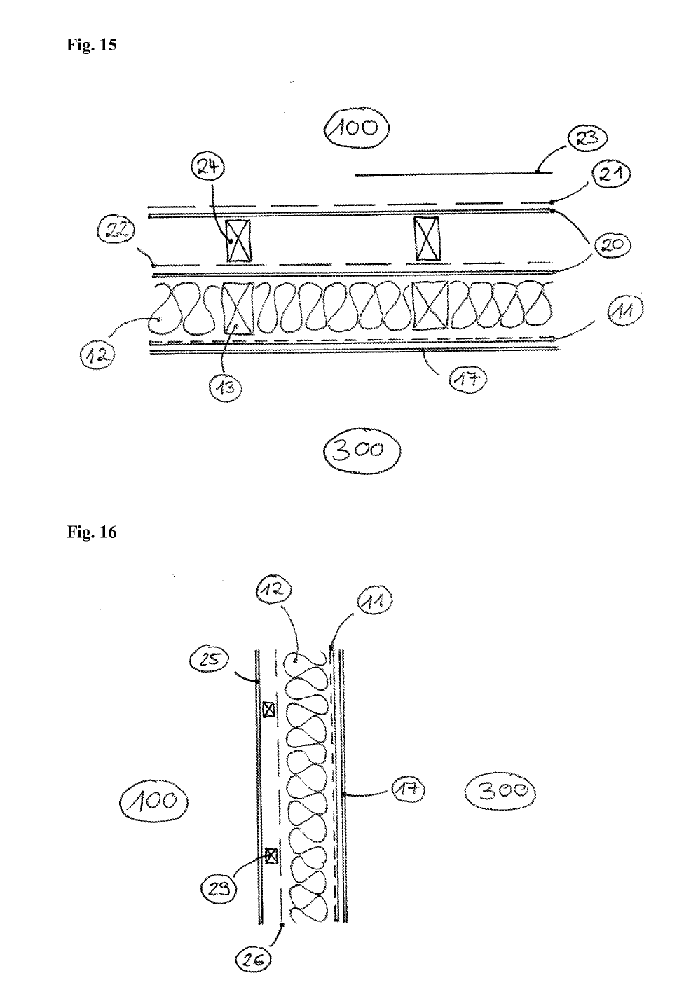

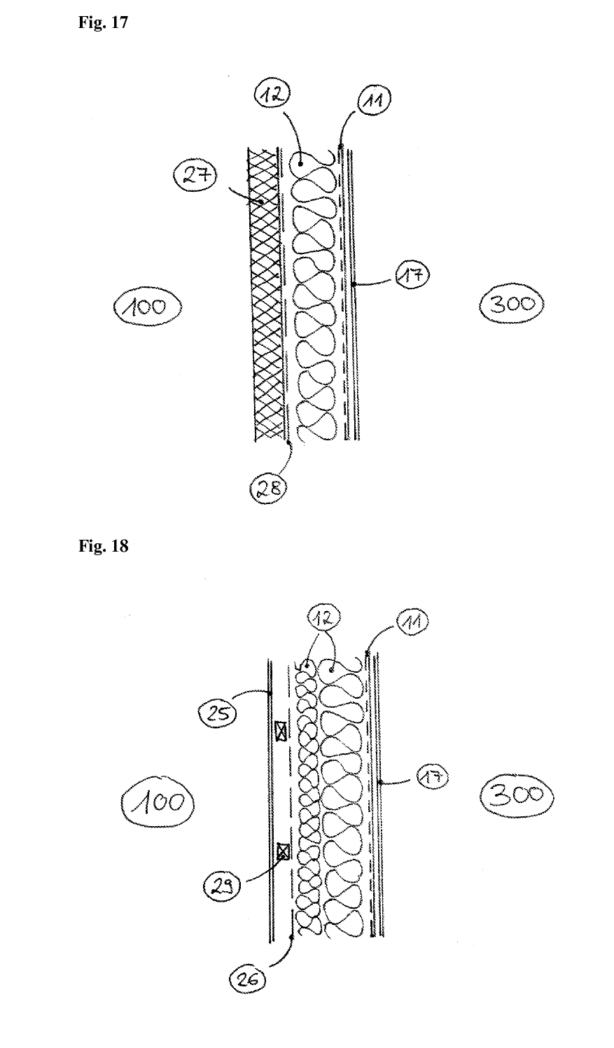

FIG. 3(b) corresponds to FIG. 3(a), wherein, in addition, the mounting of the film in the cases shown in FIGS. 4 through 25 is illustrated;

FIGS. 4, 5, 6(a), 6(b), 7 through 9 show preferred embodiments for the use of the film in a pitched roof;

FIGS. 10 through 15 show preferred embodiments for the use of the film in a flat roof;

FIGS. 16 through 18 show preferred embodiments for the use of the film in a wall structure;

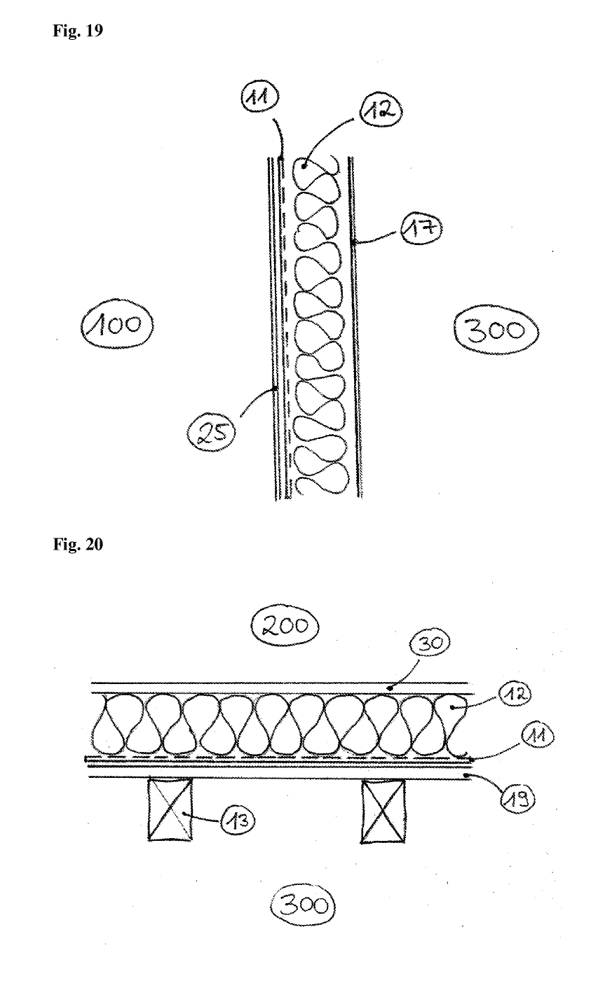

FIG. 19 shows a preferred embodiment for the use of the film in a wall structure, which structure is used in a climatic zone with high ambient humidity;

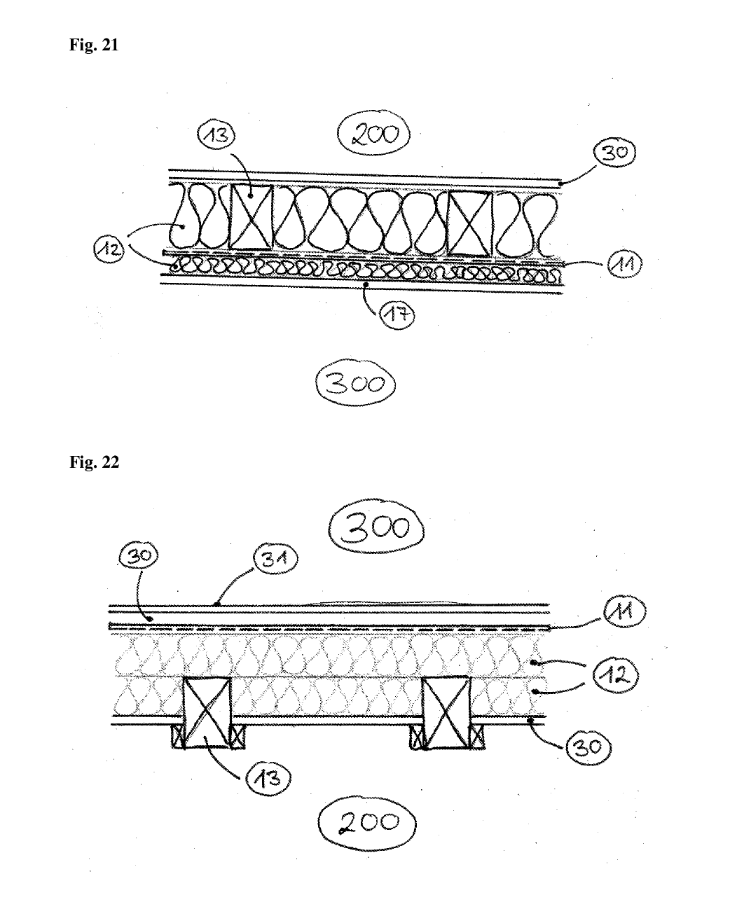

FIGS. 20 and 21 show preferred embodiments for the use of the film in an attic;

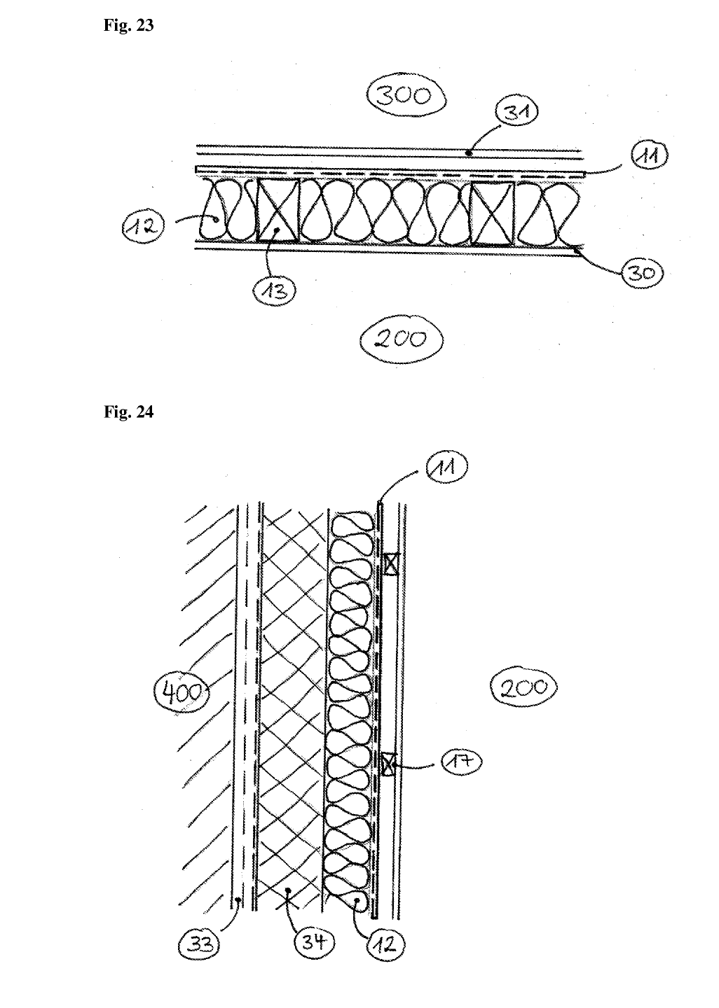

FIGS. 22 and 23 show preferred embodiments for the use of the film in a basement ceiling;

FIG. 24 shows a preferred embodiment for the use of the film on an outer wall shown from the basement to the ground.

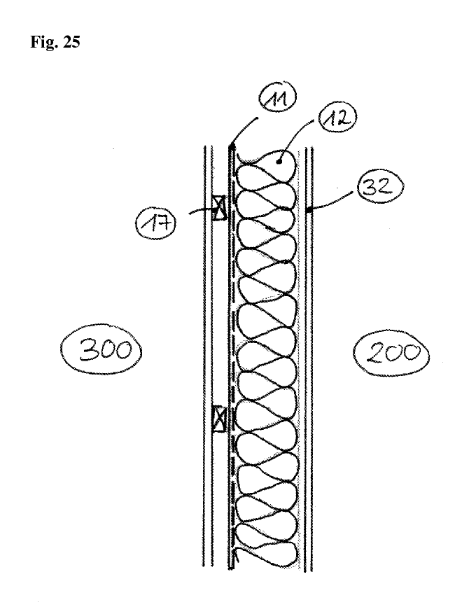

FIG. 25 shows a preferred embodiment for the use of the film on an outer wall facing the garage.

According to the invention, the vapor barrier comprises at least two layers (layer 1 and layer 2). One of the two layers, i.e. layer 1, is humidity-variable. This means that it shows an s_{d} value dependent on the relative air humidity. The other layer, i.e. layer 2, is humidity-independent or essentially humidity-invariable, thus not humidity-variable. This means that it shows an s_{d} value independent of the relative air humidity, or an essentially independent s_{d} value.

In the present case, the s_{d} value relates to a determination according to DIN EN ISO 12572:2001 with the measuring instrument GINTRONIC GraviTest 6300 according to the Dry Cup/Wet Cup method. With this method, s_{d} values at 23° C. in the dry area (0% to 50% of relative air humidity; DIN EN ISO 12572:2001 condition A/Dry Cup, 25% mean relative air humidity), (0% to 85% relative air humidity; DIN EN ISO 12572:2001 condition B/Dry Cup, 42.5% mean relative air humidity) and in the moist area (50% to 93% of relative air humidity; DIN EN ISO 12572:2001 condition C/Wet Cup, 71.5% mean relative air humidity) are determined. The measuring is done by means of a test cup analogous to DIN EN ISO 12572:2001 Appendix C. The test cup is sealed by means of the test specimen, the vapor barrier according to the invention. Within the test cup, the desired atmosphere is adjusted by use of desiccants or saline solutions. The counter-atmosphere outside of the test cup is realized by means of a climatic chamber. Thus, 25% mean relative air humidity means that during the measurement at the respective layer on one side, a relative air humidity of 0% (preferably within the test cup) and, on the other side, there is a relative air humidity of 50% (preferably outside the test cup in the climatic chamber). Correspondingly, at 71.5% mean relative air humidity, the relative air humidities are 50% and 93% (for example, a relative air humidity of 93% may be realized by means of a saturated, aqueous ammonium dihydrogen phosphate solution ((NH₄)H₂PO₄) within the test cup). For the determination of a mean relative air humidity of 42.5%, the method according to DIN EN ISO 12572:2001 condition B is applied. In the climatic chamber outside of the test cup, a relative air humidity of 85% is used, and inside the test cup, a mean relative air humidity of 0% is adjusted by means of a desiccant.

The s_{d} value of a single layer is defined by the water vapor diffusion resistance factor μ and the used layer thickness:

s_{d} value [m]=water vapor diffusion resistance factor μ×layer thickness [m]

Thus, defined s_{d} values of a single layer can be achieved over materials or material combinations which either have a high water vapor diffusion resistance factor μ and a low layer thickness or a low water vapor diffusion resistance factor μ and a high layer thickness.

The overall thickness of layer 1 and layer 2 preferably lies in the range of 20 μm to 550 μm, preferably of 35 μm to 475 μm, more preferred in the range of 55 μm to 400 μm, and most preferred from 80 μm to 350 μm, each relating to layers 1 and 2. In another preferred embodiment, the overall thickness of layer 1 and layer 2 lies between 75 μm and 550 μm. Particularly preferred is a range of 90 μm to 500 μm, more preferred of 100 μm to 350 μm. Thicknesses exceeding 550 μm may cause stiffness problems for processing as a vapor barrier in sheet form, but are not excluded.

Layer 1 preferably has a layer thickness in the range of 10 μm to 200 μm, preferably of 20 μm to 175 μm, more preferred of 30 μm to 150 μm, and most preferred of 40 μm to 125 μm. In another preferred embodiment, the thickness of layer 1 lies between 50 μm and 200 μm. Particularly preferred is a range between 60 μm and 150 μm.

Suitable materials for the humidity-variable layer 1 are polyamide, for example, polyamide 6, polyamide 66 and other polyamide types. Furthermore, ionomers are suitable. Ionomers are thermoplastics which contain at least partially functional groups such as acid groups, e.g. sulfonic acid or acrylic acid, or in which such groups may be present in the repeating units of the polymer chains. These functional groups are partly or completely neutralized by alkali or earth-alkali ions or other Lewis acids, such as aluminum or zinc cations. From EP 1 372 956 B1, the use of ionomers in vapor barriers is known. For layer 1, further materials are possible which contain basic functional groups such as, e.g., ammonium groups. Also useful are material compositions of the above-mentioned materials with other types of materials, which compositions have the necessary water vapor permeability necessary for the humidity variability of layer 1. So, for example, blends of polyamide with polyester or ethylene vinyl acetate (EVA) are possible. The material for layer 1 may furthermore also contain mineral aggregates, such as, e.g., calcium carbonate (CaCO₃), silicates and/or flameproof agents.

Layer 1 preferably has a quotient for the water vapor diffusion resistance of the s_{d} value at 25% mean relative air humidity to the s_{d} value at 71.5% mean relative air humidity greater than 4, and most preferably greater than 5.

Layer 2 has a substantially constant s_{d} value. The quotient from the s_{d} value at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is less than 1.5. Preferably, layer 2 has, at a mean relative air humidity of 71.5% (measurement according to DIN EN ISO 12571 Condition C), an s_{d} value in the range of 1 m to 20 m, preferably from 1 m to 15 m, and most preferred from 1 m to 10 m. In another preferred embodiment, the s_{d} value lies in the range of 0.2 m to 20 m, in particular from 0.3 m to 10 m.

Layer 2 preferably has a thickness of 10 μm to 350 μm, more preferably of 15 μm to 300 μm and even more preferably of 25 μm to 250 μm, and most preferably of 40 μm to 225 μm. In another preferred embodiment, the thickness of layer 2 lies between 25 μm and 350 μm. Particularly preferred is a range of 30 μm to 350 μm.

Suitable materials for humidity-independent layer 2 are materials with an s_{d} value which is substantially independent of the applied relative air humidity. Suitable materials are, for example, polyesters, thermoplastic ether-ester copolymers (TPEE), polyolefins, polyethylene (PE), high density polyethylene (HDPE), polypropylene (PP), ethylene vinyl acetate (EVA), polylactides, starch-based polymers, polyacrylates, thermoplastic polyurethanes (TPU), and combinations thereof, the s_{d} value of which is in the mentioned range. Also possible are blends, for example, of thermoplastic ether-ester copolymers (TPEE) with EVA or of thermoplastic polyurethanes (TPU) with EVA or with polyester. The material for layer 2 may contain mineral aggregates, such as, e.g., calcium carbonate (CaCO₃), silicates and/or flame proof agents. Furthermore, this layer may also consist of foamed materials, such as, e.g., those mentioned above.

Layer 2 may be formed by a foil or a film. By a film, in the present case, a closed, air-tight layer is understood. This film may be produced either by extrusion of the components consisting of the film or by coating of the components forming the film in any form. When coating, a subsequent process is necessary which creates the film from the film-forming components, this is, e.g., a process of drying, cross-linking or an otherwise activating process. In extrusion, however, the film is already formed when exiting or within 30 seconds after exiting the extruder and is only subject to a subsequent temperature change.

The connection of layers 1 and 2 for producing the vapor barrier can be obtained by bonding with an adhesive, at certain points, partially or fully, furthermore, by lamination, lining, calendaring, or by coating of one of these layers onto the other. A production of the film according to the invention as a multilayer film is also possible by means of extrusion in the blowing and casting process in multilayer extruders. Such a preferred method is described in WO 2009/065853 A1. In this method, the adhesion of a non-compatible layer, e.g. a polyester layer to polyamide, is obtained by means of suitable adhesion promoters or modified polymers. Also possible is a direct production of the multilayer film by means of extrusion blowing or casting in multilayer extruders without adhesion promoter by using TPU as layer 2 in its pure form or mixed with other aforementioned compounds.

The vapor barrier may comprise further layers in addition to layers 1 and 2. Particularly suitable are layers for increasing the mechanical strength and/or water storage. So, for example, such layers (layer 3) are suitable which serve to increase mechanical stability, such as, for example, reinforcing scrims made from polyester, polyamide, glass, polyaramide or carbon. Such a layer may be applied between the two layers (layer 1 and layer 2) or to an outer side or to both outer sides. If only one non-woven layer is applied to the outer side, it is preferably applied to the outer side of layer 1 (with the humidity-variable s_{d} value). The connection of one or more further layers with layer 1 or layer 2 or to both layers may be done by gluing, stamping, welding, lamination or lining. Also, the surface of one or both outer sides may be melted so far that, at a certain contact pressure of the further layer, a permanent bond between the different layers occurs. Furthermore, also one or more inner layers (layer 4), i.e. between layer 1 and layer 2, of water vapor retentive materials such as fleece, woven fabric, scrims or knitted fabrics are possible. These may consist of materials such as, for example, polyester, polyamide, which, due to their hydrophilic property, allow the storage of water. Also for this purpose, polyolefins such as, for example, polyethylene, polypropylene are suitable, which enable water storage between the layers by means of capillary forces. The connection of such an intermediate layer with at least two layers (layer 1 and layer 2) may be done, for preparing the vapor barrier according to the invention, by bonding with an adhesive at certain points or fully, by lamination, lining, calendaring or by the coating of layer 1 and/or layer 2 on this intermediary layer. Suitable coating processes are extrusion coating, extrusion blowing or casting, coating by dispersion and by emulsion. Also, the surface of one or both outer layers may be melted to the extent that at a certain contact pressure of the further layer a permanent bond between the different layers results. The total thickness of the effective layers 1 and 2 can be determined, for example, by means of a suitable microtome unit and a corresponding microscope.

Moreover, the film according to the invention may be combined with an outer layer (layer 5). This outer layer may be created from a non-woven fabric made of plastic material, such as, e.g., polyethylene, polypropylene, polyester, polyamide or cellulose, such as, e.g., viscose, hemp, woven fabric, scrim or knitted fabric. Such a layer serves to modify mechanical properties, i.e. to increase the tensile strength, the resistance to stretch and the tear resistance. In addition, the technical advantage of improved haptics and/or an orientation guide for the technically correct installation of the film as a vapor barrier or vapor block according to the invention may thus result for the installation technician.

The total thickness of the vapor barrier, i.e. of layer 1, layer 2 and, optionally, further layers together, preferably lies in the range of 20 μm to 700 μm, preferably from 60 μm to 600 μm, more preferably from 80 μm to 550 μm, and most preferably from 100 μm to 500 μm.

The function of the vapor barrier is illustrated in the figure. The figure shows an experimental setup for measuring the directional sensitivity, wherein the upper part of the figure, denoted by (1), shows the measuring arrangement for a large s_{d} value, and the lower part of the figure, denoted by (2), shows the measuring arrangement for a small s_{d} value. The circled numerals 1 and 2 denote layer 1 or 2, respectively, of the vapor barrier. Layer 1 is humidity-variable, layer 2 is not humidity-variable. The values 0% RH and 85% RH denote the relative air humidity which is applied to the mentioned layers 1 or 2, respectively. The arrow shows the water vapor diffusion flow. In the measuring arrangement according to (1) of the figure there is hence a relative air humidity of 85% at the humidity-variable layer 2 and the s_{d} value is greater than according to (2) in the measuring arrangement of the figure in which a relative air humidity of 85% is on the humidity-variable layer 1. The quotient from sa (large) to sa (small) is denoted as Δ. Metrologically, this experimental setup is realized in that either the side with layer 1 as outer side of the vapor barrier according to the invention is oriented towards the interior of the test cup and thus, with the Dry-Cup method (according to DIN EN ISO 12572:2001 condition B), towards the desiccant, or towards the exterior from the test cup (towards the climatic chamber).

Preferably, the vapor barrier according to the invention has, at a mean relative air humidity of 42.5%, a very strong directional sensitivity of the water vapor diffusion. This means that, depending on which side of the vapor barrier according to the invention the higher humidity is applied, the stronger is the effect of the water vapor diffusion permeability on the drier side. The s_{d} value quotient Δ (high s_{d} value/small s_{d} value=Δ) value measured according to DIN EN ISO 12572:2001 condition B with the measuring instrument GINTRONIC GraviTest 6300 at the relative air humidity of 0% to 85% and 23° C. in different directions lies in the range of 1.1 to 15, preferably from 1.2 to 12, more preferably from 1.3 to 8 and most preferably from 1.4 to 4. In a further preferred embodiment, the vapor barrier according to the invention additionally has an sa value of the total composite (i.e. including all layers) at 71.5% of mean relative air humidity (measured according to DIN EN ISO 12572:2001 condition C) of at least 1 m, preferably greater than 1 m. In another preferred embodiment, the maximum s_{d} value of the vapor barrier according to the invention at 25% mean relative air humidity (measured according to DIN EN ISO 12572:2001 condition A) is less than 40 m, preferably less than 30 m, most preferably less than 25 m, and the most preferred less than 20 m.

The invention also relates to the use of the vapor barrier for the sealing of building envelopes. The vapor barrier may be used in roof structures of buildings in order to direct the water vapor diffusion in a desired direction.

For example, the vapor barrier is arranged under the roof in such a way that layer 1 faces the roof and layer 2 faces the room in the inside. In this way, the drying of the insulation plane in the interior is always ensured, whereas the re-wetting or moistening, respectively, in the insulation is prevented. For example, if moist construction wood is used in a roof, the drying of the roof structure can take place also if the room underneath temporarily has a high room humidity, such as, e.g., bathrooms or kitchens.

The vapor barrier is humidity-variable and, due to its layer combination, directionally sensitive with regard to the property of water vapor permeability. Thus, it may be used for targeted drying of roof structures in house building without an undesired migration of humidity into the structure taking place in damp rooms such as, e.g., kitchens or bathrooms. In addition to the property of directional sensitivity, the humidity-variability of the vapor barrier according to the invention contributes to the much faster drying of the roof structure and/or the insulation plane at a high humidity content in the insulation than in the case of an exclusively directionally sensitive vapor barrier.

At the same time, also in case of a steady decrease of the moisture content in the structure, the s_{d} value is increased by the vapor barrier according to the invention for a water vapor transport from the room side into the structure, whereby a re-wetting or moistening, respectively, of the structure always occurs more slowly than the drying in the opposite water vapor diffusion direction.

The invention also includes a system which includes the vapor barrier and a component to be sealed. The component may be a material that is to be sealed in the construction field in the building envelope or in the roof area.

Furthermore, the invention relates to the use of a film for sealing a space closed by an outer skin in buildings. For example, buildings can be sealed in the direction of the construction level, e.g. in the roof area.

In a preferred embodiment, the film is a vapor barrier which is preferably used in roof structures of buildings. In another preferred embodiment of the invention, the film is used in wall structure, floor structure and/or ceiling structures of buildings.

In one embodiment, the film used in accordance with the invention comprises a film side X and an opposite film side Y which are defined such that the water vapor diffusion from film side X to film side Y is greater than the water vapor diffusion from film side Y to film side X, with the proviso that in the experimental setup according to DIN EN ISO 12572:2001 condition B (85% RH to 0% RH; 23° C.), film side X faces the side of higher relative air humidity, whereby a greater water vapor diffusion can be measured than when, at the same measurement, film side Y faces the side of the higher relative air humidity. The film is arranged for sealing in such a way that film side X is aligned with the outer skin. Preferably, the film is arranged within the closed space. In another preferred embodiment, film side X is aligned with the inner side of the outer skin. Most preferably, the film is arranged within the closed space in such a way that film side X is aligned with the inner side X of the outer skin.

In the present case, the term stating that film side X is aligned with the outer skin means that film side X lies closer to the outer skin than film side Y. Film side X may be arranged within or outside of the closed space. Similarly, the film may be arranged to the inside or the outside of the outer skin.

The term stating that film side X is aligned with the inner side of the outer skin means that film side X lies closer to the inner side of the outer skin than film side Y.

In another preferred embodiment of the invention, the film is arranged outside of the closed space. In this embodiment, preferably film side X is aligned with the outside of the outer skin. In a further preferred embodiment, the film is arranged outside of the closed space such that film side X is aligned with the outside of the outer skin.

The term stating that film side X is aligned with the outside of the outer skin means that film side X lies closer to the outside of the outer skin than film side Y.

FIG. 2 shows the operating principle of a film used according to the invention with film side X and film side Y. The film, represented with reference numeral 11, comprises film side X, shown with a dashed line, and film side Y, shown with a solid line. The thickness of the shown arrows illustrates the extent of the water vapor diffusion. From film side X, more water vapor (thicker arrow) diffuses to film side Y than water vapor (thinner arrow) diffuses from film side Y to film side X.

In another embodiment, the film used according to the invention comprises at least two layers (layer 1 and layer 2). One of both layers, layer 1, is humidity-variable or humidity-dependent. This means that it shows an s_{d} value dependent on the relative air humidity. The other layer, layer 2, is humidity-invariable or humidity-independent or, substantially humidity-invariable or humidity-independent, hence not humidity-variable. This means that it shows an s_{d} value independent of the relative air humidity or substantially independent s_{d} value. The film is arranged for sealing such that layer 1 is aligned with the outer skin. Preferably, the film is arranged within the closed space. In another preferred embodiment, layer 1 is aligned with the inside of the outer skin. Most preferably, the film is arranged within the closed space in such a way that layer 1 is aligned with the inside of the outer skin.

In the present case, the term stating that layer 1 is aligned with the outer skin means that layer 1 is closer to the outer skin than layer 2. In analogy, the term stating that layer 1 is aligned with the inside of the outer skin means that layer 1 is closer to the inside of the outer skin than film side Y.

In the present case, the s_{d} value relates to a determination according to DIN EN ISO 12572:2001 with the measuring instrument GINTRONIC GraviTest 6300 according to the Dry Cup/Wet Cup method. With this method, s_{d} values at 23° C. in the dry area (0% to 50% relative air humidity; DIN EN ISO 12572:2001 condition A/Dry Cup, 25% mean relative air humidity), (0% to 85% relative air humidity; DIN EN ISO 12572:2001 condition B/Dry Cup, 42.5% mean relative air humidity) and in the moist area (50% to 93% relative air humidity; DIN EN ISO 12572:2001 condition C/Wet Cup, 71.5% mean relative air humidity) are determined. The measuring is done by means of a test cup analogous to DIN EN ISO 12572:2001 Appendix C. The test cup is sealed by means of the test specimen, i.e. the film. Within the test cup, the desired atmosphere is adjusted by use of a desiccant or saline solutions. The counter-atmosphere outside of the test cup is realized by means of a climatic chamber. Thus, 25% mean relative air humidity means that during the measurement at the respective layer on one side, there is a relative air humidity of 0% (preferably within the test cup) and, on the other side, a relative air humidity of 50% (preferably outside the test cup in the climatic chamber). Correspondingly, at 71.5% mean relative air humidity, the relative air humidities are 50% and 93% (for example, a relative air humidity of 93% may be realized by means of a saturated, aqueous ammonium dihydrogen phosphate solution ((NH₄)H₂PO₄) within the test cup). For the determination of a mean relative air humidity of 42.5%, the method according to DIN EN ISO 12572:2001 condition B is applied. In the climatic chamber outside of the test cup, a relative air humidity of 85% is used, and inside the test cup, a mean relative air humidity of 0% is set by means of a desiccant.

The s_{d} value of a single layer is defined by the water vapor diffusion resistance factor μ and the used layer thickness:

s_{d} value [m]=water vapor diffusion resistance factor μ×layer thickness [m]

Thus, defined s_{d} values of a single layer may be obtained over materials or material combinations which either have a high water vapor diffusion resistance factor μ and a small layer thickness or a low water vapor diffusion resistance factor μ and a high layer thickness.

The overall thickness of layer 1 and layer 2 preferably lies in the range of 20 μm to 550 μm, preferably of 35 μm to 475 μm, more preferred in the range of 55 μm to 400 μm, and most preferred from 80 μm to 350 μm, relating to layers 1 and 2, respectively. In another preferred embodiment, the overall thickness of layer 1 and layer 2 lies between 75 μm and 550 μm. Particularly preferred is a range of 90 μm to 500 μm, more preferred from 100 μm to 350 μm. Thicknesses exceeding 550 μm may cause stiffness problems for the processing of a film in sheet form, but are not excluded.

Layer 1 preferably has a layer thickness in the range of 10 μm to 200 μm, preferably of 20 μm to 175 μm, more preferred of 30 μm to 150 μm, and most preferred of 40 μm to 125 μm. In another preferred embodiment, the thickness of layer 1 lies between 50 μm and 200 μm. Particularly preferred is a range between 60 μm and 150 μm.

Suitable materials for the humidity-variable layer 1 are polyamide, for example, polyamide 6, polyamide 66 and other polyamide types. Furthermore, ionomers are suitable. Ionomers are thermoplastics which contain at least partially functional groups such as acid groups, e.g. sulfonic acid or acrylic acid, or in which such groups may be present in the repeating units of the polymer chains. These functional groups are partly or completely neutralized by alkali or earth-alkali ions or other Lewis acids, such as aluminum or zinc cations. From EP 1 372 956 B1, the use of ionomers in vapor barriers is known. For layer 1, further materials are possible which contain basic functional groups such as, e.g., ammonium groups. Also useful are material compositions of the above-mentioned materials with other types of materials, which compositions have the necessary water vapor permeability necessary for the humidity variability of layer 1. So, for example, blends of polyamide with polyester or ethylene vinyl acetate (EVA) are possible. The material for layer 1 may furthermore also contain mineral aggregates, such as, e.g., calcium carbonate (CaCO₃), silicates and/or flameproof agents.

Further suitable materials for layer 1 are polyvinyl alcohols, ethylene vinyl alcohol or other copolymerized vinyl alcohols or hydrolyzed vinyl acetates. Also suitable are blends of ethylene vinyl alcohol, polyvinyl alcohol, copolymerized vinyl alcohols, hydrolyzed vinyl acetates or ionomers with polyester, ethylene vinyl acetate (EVA), polyethylene, polypropylene, thermoplastic polyurethanes or other components miscible with these humidity-variable polymers. As aggregates, layer 1 may also contain mineral aggregates such as, for example, calcium carbonate (CaCO₃), silicates and/or flameproof agents and/or UV stabilizers.

Layer 1 of the film preferably has a quotient for the water vapor diffusion resistance of the s_{d} value at 25% mean relative air humidity to the s_{d} value at 71.5% mean relative air humidity greater than 4, and most preferably greater than 5.

Layer 2 has a substantially constant s_{d} value. The quotient from the s_{d} value at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is less than 1.5. Preferably, layer 2 has, at a mean relative air humidity of 71.5% (measurement according to DIN EN ISO 12571 condition C), an s_{d} value in the range of 1 m to 20 m, preferably from 1 m to 15 m, and most preferred from 1 m to 10 m. In another preferred embodiment, the s_{d} value lies in the range of 0.2 m to 20 m, in particular from 0.3 m to 10 m.

Layer 2 preferably has a thickness of 10 μm to 350 μm, more preferably from 15 μm to 300 μm and even more preferably from 25 μm to 250 μm, and most preferably from 40 μm to 225 μm. In another preferred embodiment, the thickness of layer 2 lies between 25 μm and 350 μm. Particularly preferred is a range of 30 μm to 350 μm.

Suitable materials for moisture-independent layer 2 are materials with an s_{d} value which is substantially independent of the applied relative air humidity. Suitable materials are, for example, polyesters, thermoplastic ether-ester copolymers (TPEE), polyolefins, polyethylene (PE), high density polyethylene (HDPE), polypropylene (PP), ethylene vinyl acetate (EVA), polylactides, starch-based polymers, polyacrylates, thermoplastic polyurethanes (TPU), and combinations thereof, the s_{d} value of which is in the mentioned range. Also possible are blends of, for example, thermoplastic ether-ester copolymers (TPEE) with EVA or of thermoplastic polyurethanes (TPU) with EVA or with polyester. The material for layer 2 may contain mineral aggregates, such as, e.g., calcium carbonate (CaCO₃), silicates and/or flameproof agents. Furthermore, this layer may also consist of foamed materials, such as, e.g., those mentioned above.

Layer 2 may be formed of a foil or a film. By a film, in the present case, a closed, air-tight layer is understood. This film may be produced either by extrusion of the components consisting of the film or by coating of the components forming the film in any form. When coating, a subsequent process is necessary which creates the film from the film-forming components, this is, e.g., a process of drying, cross-linking or an otherwise activating process. In extrusion, however, the film is already formed at or within 30 seconds after exiting the extruder and is only subject to a subsequent temperature change.

The connection of layers 1 and 2 for producing the vapor barrier can be obtained by bonding with an adhesive, at certain points, partially or fully, furthermore, by lamination, lining, calendaring, or by coating of one of these layers onto the other. A production of the film according to the invention as a multilayer film is also possible by means of extrusion in the blown- and casting process in multilayer extruders. Such a preferred method is described in WO 2009/065853 A1. In this method, the adhesion of a non-compatible layer, e.g. a polyester layer to polyamide, is obtained by means of suitable adhesion promoters or modified polymers. Also possible is a direct production of the multilayer film by means of extrusion in the blown- or casting process in multilayer extruders without adhesion promoter by using TPU as layer 2 in its pure form or mixed with other aforementioned compounds.

In one embodiment, the film comprises at least two layers. Preferably, the film is multilayered. In particular, the film comprises at least three, four, five or six layers, particularly at least three layers or at least four layers.

The film may comprise further layers in addition to layers 1 and 2. Particularly suitable are layers for increasing the mechanical strength and/or water storage. So, for example, such layers (layer 3) are suitable which serve to increase mechanical stability, such as, for example, reinforcing scrims made from polyester, polyamide, glass, polyaramide or carbon. Such a layer may be applied between the two layers (layer 1 and layer 2) or to an outer side or to both outer sides. If only one non-woven layer is applied to the outer side, this is preferably applied to the outer side of layer 1 (with the humidity-variable sa value). The connection of one or more further layers with layer 1 or layer 2 or to both layers may be done by gluing, stamping, welding, lamination or lining. Also, the surface of one or both outer sides may be melted so far that, at a certain contact pressure of the further layer, a permanent bond between the different layers occurs. Furthermore, also one or more inner layers (layer 4), i.e. between layer 1 and layer 2, of water vapor retentive materials such as fleece, woven fabric, scrims or knitted fabrics are possible. These may consist of materials such as, for example, polyester, polyamide, which, due to their hydrophilic property, allow the storage of water. Also for this purpose, polyolefins such as, for example, polyethylene, polypropylene are suitable, which enable water storage between the layers by means of capillary forces. The connection of such an intermediate layer with at least two layers (layer 1 and layer 2) may be done, for preparing the film according to the invention, by bonding with an adhesive at certain points or fully, by lamination, lining, calendaring or by the coating of layer 1 and/or layer 2 on this intermediary layer. Suitable coating processes are extrusion coating, extrusion blowing or casting, coating by dispersion and by emulsion. Also, the surface of one or both outer layers may be melted to the extent that at a certain contact pressure of the further layer a permanent bond between the different layers results. The total thickness of the effective layers 1 and 2 can be determined, for example, by means of a suitable microtome unit and a corresponding microscope.

Moreover, the film according to the invention may be combined with an outer layer (layer 5). This outer layer may be created from a non-woven fabric made of plastic material, such as, e.g., polyethylene, polypropylene, polyester, polyamide or cellulose, such as, e.g., viscose, hemp, woven fabric, scrim or knitted fabric. Such a layer serves to modify mechanical properties, i.e. to increase the tensile strength, resistance to stretch and tear resistance. In addition, the technical advantage of improved haptics and/or an orientation guide for the technically correct installation of the film, in particular as a vapor barrier or vapor block, may thus result for the installation technician.

The arrangement of the layers, particularly of layer 1 and layer 2 within the film used according to the invention, and the number of additional layers are not restricted. For example, a further layer 3, layer 4 and, optionally, one or more further layers may be arranged both between layer 1 and layer 2 and the outer side of layer 1 and/or layer 2. Similarly, the other layers of the film according to the invention may, if the latter is a multilayered film with n layers, wherein n is an integer and greater than or equal to 2, consist of materials which either fall under the aforementioned definition of the humidity-variable layer (layer 1) and/or the aforementioned definition of the essentially humidity-independent layer (layer 2).

The total thickness of the film, i.e. of layer 1, layer 2 and, optionally, further layers, preferably lies in the range of 20 μm to 700 μm, preferably from 60 μm to 600 μm, more preferably from 80 μm to 550 μm and most preferably from 100 μm to 500 μm.

In one embodiment, a film with two film sides X and Y is used, wherein, for further explanation, reference is made to the experimental setup represented in FIG. 1 and which was already used for the determination of quotient Δ. The film is characterized by 2 measurement series. In the first measurement series, the film is measured with a determined film side facing the higher relative air humidity according to DIN EN ISO 12572:2001 condition B. In the second measurement series, the film is turned around and the measurement is again performed according to DIN EN ISO 12572:2001 condition B, with the film side which previously in the experimental setup was not oriented to the higher relative air humidity now facing this higher relative air humidity. Depending on the measurement series, the film has a different s_{d} value. The experimental setup of the measurement series with the smaller s_{d} value as measurement result defines film side X. If the film side X is oriented to the higher relative air humidity in this measurement setup, the water vapor diffusion of film side X to film side Y is always greater than the water vapor diffusion of film side Y to film side X in the test setup according to DIN EN ISO 12572:2001 condition B (85% RH to 0% RH; 23° C.).

The operation of a film with layer 1 and layer 2 is further illustrated in FIG. 1. FIG. 1 shows a test setup for measuring the directional sensitivity, wherein the upper part of the Figure, denoted by (1), shows the measuring arrangement for a large s_{d} value, and the lower part of the figure, denoted by (2), shows the measuring arrangement for a small s_{d} value. The circled numerals 1 and 2 denote layer 1 or layer 2, respectively, of the film, in particular a vapor barrier. Layer 1 is humidity-variable, layer 2 is not humidity-variable. Values 0% RH and 85% RH denote the relative air humidity applied to the specified layer 1 or 2, respectively. The arrow shows the water vapor diffusion flow. In the measuring arrangement according to (1) of the figure, a relative air humidity of 85% is applied to the non-humidity-variable layer 2, and the s_{d} value is greater than in the measuring arrangement according to (2) of the figure in which a relative air humidity of 85% is applied to the humidity-variable layer 1. The quotient from sa (large) to sa (small) is defined as Δ. Metrologically, this test setup is realized by either orienting the side with layer 1 as outer side of the film to the inside of the test cup and thus, by the Dry-Cup method (according to DIN EN ISO 12572:2001 condition B) to the desiccant, or outwardly from the test cup (to the climatic chamber).

The film used according to the invention essentially preferably shows, at a mean relative air humidity of 42.5%, a very strong directional sensitivity of the water vapor diffusion. This means that, depending on which side of the film the higher humidity is applied, the more the water vapor diffusion permeability impinges on the drier side.

The s_{d} value quotient Δ (high s_{d} value/small s_{d} value=Δ) measured according to DIN EN ISO 12572:2001 condition B with the measuring instrument GINTRONIC GraviTest 6300 at the relative air humidities of 0% to 85% and 23° C. in different directions lies in the range of 1.1 to 15, preferably from 1.2 to 12, more preferably from 1.3 to 8 and most preferably from 1.4 to 4. In a further preferred embodiment, the film used according to the invention additionally has an s_{d} value of the total composite (i.e. including all layers) at 71.5% of mean relative air humidity (measured according to DIN EN ISO 12572:2001 condition C) of at least 1 m, preferably greater than 1 m. In another preferred embodiment, the maximum s_{d} value of the film at 25% mean relative air humidity (measured according to DIN EN ISO 12572:2001 condition A) is less than 40 m, preferably less than 30 m, most preferably less than 25 m, and the most preferred less than 20 m.

In particular, the invention relates to the use of the film for sealing spaces in buildings, wherein the spaces are closed by an outer skin. In particular, building envelopes can be sealed therewith. The alignment of the film is made by film side X or layer 1 to the outer skin. Preferably, the outer skin is a construction level in a building. The construction level specifies in the wall structure, floor structure and/or ceiling structure of the building or in the roof structure of the building the level in which structural elements can be used. These structural elements can, for example, be an inserted wood construction, a steel construction or other elements with structural properties. As examples of this, a roof structure with structural wooden elements or a wall structure with wall construction elements made of wood or steel are mentioned. For example, a wood construction being present in the roof may concurrently also contain insulating elements. The application of the film with film side Y to this construction level causes a better drying of the construction level through the film into the environment present at the other side of the film. For example, the film may be used in roof structures of buildings such as to direct the water vapor diffusion in a desired direction.

As a preferred embodiment of an outer skin, an example of a house is schematically shown in FIG. 3(a). In FIG. 3(a), reference numeral 100 denotes the space outside of the house, i.e. outside of the outer skin; reference numeral 200 denotes buffer spaces, for example basement, garage, attic, or unheated space; reference numeral 300 denotes interiors; and reference numeral 400 denotes soil. Thus, reference numeral 100 illustrates the outside climate, reference numeral 200 illustrates the buffer climate and reference numeral 300 illustrates the indoor climate. FIG. 3(a) shows, by means of the circles with a circled horizontal or vertical thick line, at which points in the house the film can be applied in order to achieve the desired seal. The film can be applied under the roof, but also in the basement or in the outer wall of the house, or between the garage and the adjacent wall of the house.

According to the invention, the outer skin is not limited to the house schematically represented in FIG. 3(a). The outer skin may take any form and is not subject to specific restrictions.

Referring to FIG. 3(a), the film may preferably be arranged under a roof in such a way that film side X faces the roof (the construction level or outer skin), and film side Y internally faces the room. In this preferred embodiment, the film is arranged inside the room and film side X is oriented to the inside of the roof, i.e. the construction level/outer skin. This means that film side Y is farther away from the construction level/outer skin than film side X. With this arrangement of the film, the drying of the construction level, which may comprise an insulation layer, towards the interior is ensured, whereas a re-wetting or humidity addition to the construction level or insulation is inhibited. For example, if moist construction wood is used in a roof, the drying of the roof structure can take place even if the space beneath has a temporarily high room humidity, such as bathrooms or kitchens.

The film used according to the invention is humidity-variable and, due to its layer combination, directionally sensitive as regards the property of water vapor permeability. Therefore, it may be used for a targeted drying of constructions in house building without an undesired migration of humidity to the construction in damp rooms such as, e.g., kitchens and bathrooms taking place. At the same time, also with a continuous decrease of the moisture content in the construction, the s_{d} value for a water vapor transport from the room side through the film to the construction rises, which has the effect that a re-wetting or moisture addition of the construction always takes place more slowly than the drying in the opposite water vapor diffusion direction.

Preferred embodiments of the invention are shown in FIGS. 4 through 25. FIG. 3(b) shows the possible use of the film in the cases shown in FIGS. 4 through 25. FIGS. 4 through 25 are self-explanatory by themselves for the person skilled in the art on the basis of the reference numerals. In the figures, the following reference numerals designate the following features:
11 Film;
12 Insulation;
13 Supporting structure, e.g. rafters or beams, etc.;
14 Roofing underlayment or roof board
15 Battens;
16 Battens and roofing;
17 Interior trim;
18 Double-sided adhesive tape or fixing aid for air-tight fixing of film side Y;
19 Formwork;
20 Laying underlay;
21 Waterproofing membrane;
22 Internal waterproofing membrane;
23 Substrate (e.g. gravelling, greening, floor covering, etc.);
24 Doubling;
25 Cladding;
26 Facing sheet;
27 Truss;
28 Separating layer;
29 Batten for rear ventilation;
30 Wood-based panel;
31 Flooring;
32 Gypsum-fiberboard planking;
33 Drainage;
34 Concrete;
100 Space outside the outer skin;
200 Buffer space, e.g. basement, garage, attic, or unheated room;
300 Interior; and
400 Soil.

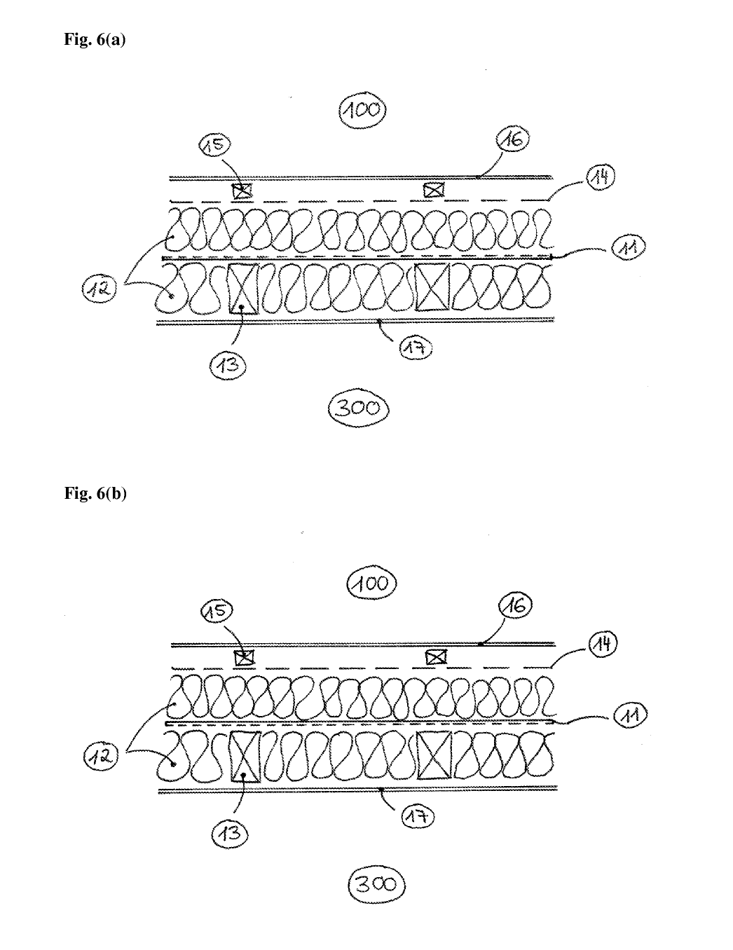

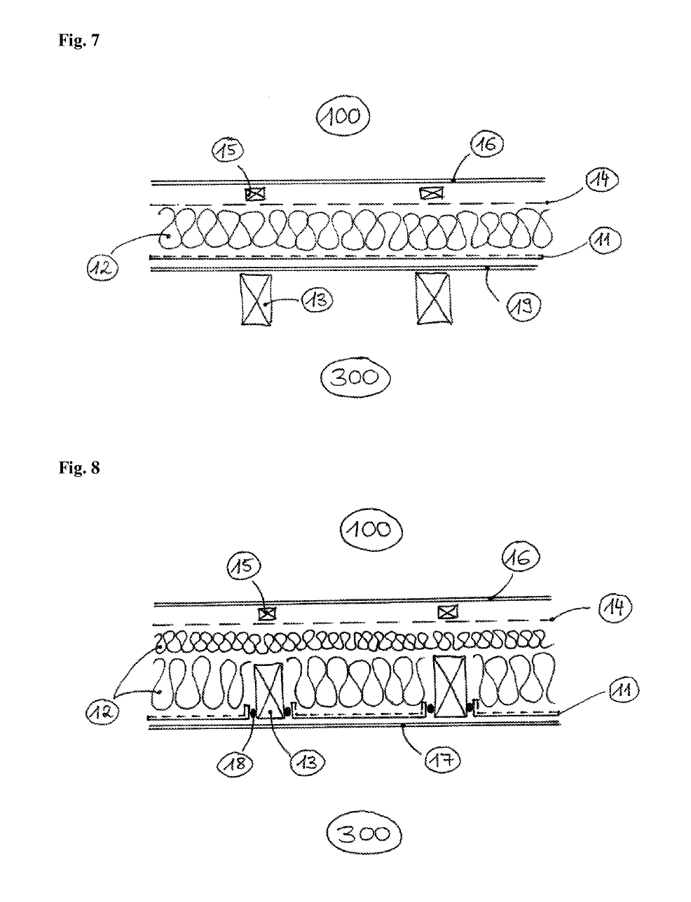

FIGS. 4, 5, 6(a), 6(b), 7, 8 and 9 show preferred embodiments for the use of the film 11 in different pitched roof structures. In the figures, the film 11 is represented with film side X to the insulation 12. In FIGS. 6(a) and 6(b), two insulation planes 12 are showed. When using the film between several insulation planes, the film is aligned in accordance with the insulation to be protected from humidity, as shown in FIG. 6(a) or 6(b). This means that film side X is oriented to the side which is to be protected or dried out, respectively. FIGS. 7, 8 and 9 show the use of the film at a renovation of a roof structure from the outside. Here, superstructures are shown in the figures. In FIG. 7, film side X is oriented to the insulation to be protected from moisture. This makes it necessary in the case of renovation that the film is oriented to parts of the structural elements with film side Y. In this case, given an entangled laying, an air-tight fixation of film side Y to the structural element is advantageous according to FIG. 7.

FIGS. 10 to 15 show preferred embodiments for the use of the film in different flat roof structures, wherein the options of use from FIG. 3(b) can be seen.

FIG. 16 to 18 show preferred embodiments for the use of the film in different wall structures, wherein the options of use from FIG. 3(b) can be seen.

FIGS. 20 and 21 show preferred embodiments for the use of the film in an attic, wherein the options of use from FIG. 3(b) can be seen.

FIGS. 22 and 23 show preferred embodiments for use of the film in a basement ceiling, wherein the options of use from FIG. 3(b) can be seen.

FIG. 24 shows a preferred embodiment for the use of the film at an outer wall which goes from the basement to the soil, cf. FIG. 3(b).

FIG. 25 shows a preferred embodiment for the use of the film at an outer wall which goes to the garage, cf. FIG. 3(b).

In other preferred embodiments, the film used according to the invention may also be used for protecting the construction level in the outdoor area. This is particularly the case in situations where the climate outside of the building always has a higher relative air humidity and/or temperature as compared to the interior of the building. In this case, the construction level is to be protected from the humidity penetrating from the outside climate so as to prevent a condensation of humidity within the construction. For this purpose, the film is applied on the construction level from the outside, with film side X facing the construction level and film side Y the outside. For an example, reference is made to FIG. 19.

FIG. 19 shows a preferred embodiment for the use of the film in a wall structure, this embodiment being used in a climatic zone with high ambient humidity. The arrangement shown in FIG. 19 can be used for targeted protection of in house building without an undesired migration of humidity into the structure taking place in very wet climatic regions. At the same time, also in case of a steady decrease of the humidity content in the construction, the s_{d} value for a water vapor transport from the outside into the construction through the film used in accordance with the invention rises, whereby the re-moistening of the construction always occurs more slowly than the drying in the opposite water vapor diffusion direction.

The invention also relates to a method for sealing a space closed by an outer skin in buildings, wherein a film with a film side X and an opposite film side Y is arranged such that film side X is aligned with the outer skin, wherein film sides X and Y are defined such that the water vapor diffusion from film side X to film side Y is greater than the water vapor diffusion from film side Y to film side X, with the proviso that in the experimental setup according to DIN EN ISO 12572:2001 condition B (85% RH to 0% RH; 23° C.), film side X faces the side with higher relative air humidity and thus a greater water vapor diffusion can be measured than if, at the same measurement, film side Y faces the side with higher relative air humidity.

The invention further relates to a method for sealing a space closed by an outer skin in buildings, wherein a film comprises at least two layers, wherein one layer (layer 1) is humidity-variable and the quotient for the water vapor diffusion resistance from the sa value at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is greater than 3, and the other layer (layer 2) is substantially humidity-invariable and the quotient from the s_{d} value at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is less than 1.5, wherein the film is arranged such that layer 1 is aligned with the outer skin.

Preferred embodiments of the method using the film are defined such as they are described above in the use of the film.

The invention also comprises a system which includes the film and an outer skin. The film and the outer skin are preferably defined such as described above.

The invention is illustrated by the following examples which show preferred embodiments of the invention without limiting the scope thereof.

### EXAMPLES

### Example 1

A 0.050 mm thick polyamide (PA) film (for example, the product Isover Vario KM, or Difunorm Vario, respectively) is combined with a second film of a thickness of 0.152 mm, based on a mixture of ethylene-vinyl-acetate (EVA) and a thermoplastic-elastomeric ether-ester-block copolymer (TPE-E) according to patent DE 10 2006 018 351 B4. The combination of these two films is performed by spot-bonding with a hot-melt adhesive (Hotmelt) of the type Alfa H 5000/0 of the company Alfa Klebstoffe AG. The spot-bonding takes place over a square grid of 10 mm, in which each intersection point of the grid contains a hot-melt adhesive point applied in a diameter of 1 mm. After application of these points to the polyamide film, the latter is covered plane with the second film and pressed by means of rolling with a foam roller.

The resulting multilayer film has a total thickness of 0.202 mm outside the spot-bonding.

The s_{d} values listed in Table 1 below were determined according to the Dry-Cup or Wet Cup method, respectively, DIN EN ISO 12572:2001, conditions A, B and C, wherein the individual samples, as indicated, were measured with layer 1 or layer 2, respectively, as the side facing the test atmosphere. In the present case, RH means the relative air humidity.

TABLE 1

| Measurement | | | | |
|---|---|---|---|---|
| DRY CUP | | | | |
| 0/50 | | | Side facing the | |
| DIN 12572 | | | test chamber | S_{d} value |
| Condition A | Layer 1 | Layer 2 | (50% RH) | [m] |
| 1 | PA | TPE-E/EVA | Layer 1 | 5.0 |
| | 0.050 mm | 0.152 mm | | |
| 2 | PA | TPE-E/EVA | Layer 2 | 5.8 |
| | 0.050 mm | 0.152 mm | | |
| 3 | PA | — | Monolayer 1 | 3.5 |
| | 0.050 mm | | | |
| 4 | — | TPE-E/EVA | Monolayer 2 | 1.7 |
| | | 0.152 mm | | |
| Measurement | | | | |
| DRY CUP | | | | |
| 0/85 | | | Side facing the | |
| DIN 12572 | | | test chamber | S_{d} value |
| Condition B | Layer 1 | Layer 2 | (85% RH) | [m] |
| 1 | PA | — | Monolayer 1 | 1.8 |
| | 0.050 mm | | | |
| 2 | — | TPE-E/EVA | Monolayer 2 | 1.7 |
| | | 0.152 mm | | |
| 3 | PA | TPE-E/EVA | Layer 1 | 1.9 |
| | 0.050 mm | 0.152 mm | | |
| 4 | PA | TPE-E/EVA | Layer 2 | 4.1 |
| | 0.050 mm | 0.152 mm | | |
| Measurement | | | | |
| WET CUP | | | | |
| 93/50 | | | Side facing the | |
| DIN 12572 | | | test chamber | S_{d} value |
| Condition C | Layer 1 | Layer 2 | (50% RH) | [m] |
| 1 | PA | TPE-E/EVA | Layer 1 | 2.9 |
| | 0.050 mm | 0.152 mm | | |
| 2 | PA | TPE-E/EVA | Layer 2 | 1.8 |
| | 0.050 mm | 0.152 mm | | |
| 3 | PA | — | Monolayer 1 | 0.5 |
| | 0.050 mm | | | |
| 4 | — | TPE-E/EVA | Monolayer 2 | 1.6 |
| | | 0.152 mm | | |

### Example 2

A 0.050 mm thick polyamide (PA) film (for example, the product Isover Vario KM, or Difunorm Vario, respectively) is combined with a second film of a thickness of 0.117 mm, based on a mixture of ethylene-vinyl-acetate (EVA) and a thermoplastic-elastomeric ether-ester-block copolymer (TPE-E) according to patent DE 10 2006 018 351 B4. The combination of these two films is performed by spot-bonding with a hot-melt adhesive (Hotmelt) of the type Alfa H 5000/0 of the company Alfa Klebstoffe AG. The spot-bonding takes place over a square grid of 10 mm, in which each intersection point of the grid contains a hot-melt adhesive point applied in a diameter of 1 mm. After application of these points to the polyamide film, the latter is covered plane with the second film and pressed by means of rolling with a foam roller.

The resulting multilayer film has a total thickness of 0.167 mm outside the spot-bonding.

The s_{d} values listed in Table 2 below were determined according to the Dry-Cup or Wet Cup methods, respectively, DIN EN ISO 12572:2001, conditions A, B and C, wherein the individual samples, as indicated, were measured with layer 1 or layer 2, respectively, as the side facing the test atmosphere.

TABLE 2

| Measurement | | | | |
|---|---|---|---|---|
| DRY CUP | | | | |
| 0/50 | | | Side facing the | |
| DIN 12572 | | | test chamber | S_{d} value |
| Condition A | Layer 1 | Layer 2 | (50% RH) | [m] |
| 1 | PA | TPE-E/EVA | Layer 1 | 4.6 |
| | 0.050 mm | 0.117 mm | | |
| 2 | PA | TPE-E/EVA | Layer 2 | 5.2 |
| | 0.050 mm | 0.117 mm | | |
| 3 | PA | — | Monolayer 1 | 3.5 |
| | 0.050 mm | | | |
| 4 | — | TPE-E/EVA | Monolayer 2 | 1.3 |
| | | 0.117 mm | | |
| Measurement | | | | |
| DRY CUP | | | | |
| 0/85 | | | Side facing the | |
| DIN 12572 | | | test chamber | S_{d} value |
| Condition B | Layer 1 | Layer 2 | (85% RH) | [m] |
| 1 | PA | — | Monolayer 1 | 1.8 |
| | 0.050 mm | | | |
| 2 | — | TPE-E/EVA | Monolayer 2 | 1.3 |
| | | 0.117 mm | | |
| 3 | PA | TPE-E/EVA | Layer 1 | 2.0 |
| | 0.050 mm | 0.117 mm | | |
| 4 | PA | TPE-E/EVA | Layer 2 | 3.8 |
| | 0.050 mm | 0.117 mm | | |
| Measurement | | | | |
| WET CUP | | | | |
| 93/50 | | | Side facing the | |
| DIN 12572 | | | test chamber | S_{d} value |
| Condition C | Layer 1 | Layer 2 | (50% RH) | [m] |
| 1 | PA | TPE-E/EVA | Layer 1 | 2.4 |
| | 0.050 mm | 0.117 mm | | |
| 2 | PA | TPE-E/EVA | Layer 2 | 1.4 |
| | 0.050 mm | 0.117 mm | | |
| 3 | PA | — | Monolayer 1 | 0.5 |
| | 0.050 mm | | | |
| 4 | — | TPE-E/EVA | Monolayer 2 | 1.2 |
| | | 0.117 mm | | |

The s_{d} values measured depending on the orientation of the vapor barrier illustrate the directional sensitivity of the vapor barrier.

1. Use of a film for sealing a space closed by an outer skin in buildings, wherein the film has a film side X and an opposite film side Y and the film is arranged such that the film side X is aligned with the outer skin, wherein the film sides X and Y are defined such that the water vapor diffusion from film side X to film side Y is greater than the water vapor diffusion from film side Y to film side X, with the proviso that in the experimental set-up according to DIN EN ISO 12572:2001 condition B (85% RH to 0% RH; 23° C.), film side X is aligned with the side of higher relative air humidity, whereby a greater water vapor diffusion can be measured than when at the same measurement, film side Y faces the side of higher relative air humidity.

2. Use of a film for sealing a space closed by an outer skin in buildings, wherein the film comprises at least two layers, wherein one layer (layer 1) is humidity-variable and the quotient of water vapor diffusion resistance from the s_{d} value at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is greater than 3, and the other layer (layer 2) is essentially humidity-invariable and the quotient of the s_{d} value at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is less than 1.5, wherein the film is arranged such that layer 1 is aligned with the outer skin.

3. Use according to claim 1 or 2, wherein the layer 1 is aligned with film side X, or the outer side of layer 1 forms film side X.

4. Use according to one of claims 1 to 3, wherein the film is arranged within the closed space.

5. Use according to one of claims 1 to 3, wherein the film is arranged outside of the closed space.

6. Use according to one of claims 1 to 5, wherein the film is a vapor barrier.

7. Use according to one of claims 1 to 5, wherein the outer skin is formed by wall structures, floor structures and/or ceiling structures in buildings.

8. Use according to one of claims 2 to 7, wherein the film comprises layer 1, layer 2 and at least one further layer, in particular for increasing the mechanical strength and/or water storage.

9. Use according to one of claims 1 to 8, wherein the total thickness of the film lies in the range of 20 μm to 700 μm, preferably from 60 μm to 600 μm.

10. Use according to one of claims 2 to 9, wherein layer 1 has a thickness in the range of 10 μm to 200 μm, preferably between 50 μm and 200 μm, and/or layer 2 has a thickness in the range of 10 μm to 350 μm, preferably between 25 μm and 350 μm.

11. Use according to one of claims 2 to 10, wherein the material for layer 1 is selected from the group consisting of polyamide, ionomers, polyvinyl alcohols, ethylene vinyl alcohol, hydrolyzed vinyl acetates, blends of ethylene vinyl alcohol, polyvinyl alcohol or hydrolyzed vinyl acetates, and blends of ionomers with polyester, ethylene vinyl acetate, polyethylene, polypropylene or thermoplastic polyurethanes.

12. Use according to one of claims 2 to 11, wherein the material for layer 2 is selected from the group consisting of polyester, thermoplastic ether-ester copolymers (TPEE), polyolefins, polyethylenes, high density polyethylene (HDPE), polypropylene (PP), ethylene vinyl acetate (EVA), polylactides, starch-based polymers, polyacrylates, thermoplastic polyurethanes (TPU), and combinations thereof.

13. Use according to one of claims 2 to 12, wherein, for layer 1, the quotient for the water vapor diffusion resistance of the s_{d} value at 25% mean relative air humidity to the s_{d} value at 71.5% mean relative air humidity is greater than 4, preferably greater than 5, and/or the layer 2 at 71.5% relative air humidity has an s_{d} value in the range of 1 m to 20 m, preferably of 1 m to 15 m.

14. Use according to one of claims 2 to 13, wherein layer 2 is formed as a foil or film.

15. Use according to one of claims 1 to 14, wherein the outer skin comprises a roof, ceiling, wall or floor construction.

16. Use according to one of claims 1 to 15, wherein the outer skin comprises steel and/or wood and, optionally, insulating elements.

17. Method for sealing a space closed by an outer skin in buildings, wherein a film having a film side X and an opposite film side Y is arranged such that the film side X is aligned with the outer skin, wherein the film sides X and Y are defined such that the water vapor diffusion from film side X to film side Y is greater than the water vapor diffusion from film side Y to film side X, with the proviso that in the experimental set-up according to DIN EN ISO 12572:2001 condition B (85% RH to 0% RH; 23° C.), film side X faces the side of higher relative air humidity, whereby a greater water vapor diffusion can be measured than when, at the same measurement, film side Y faces the side of higher relative air humidity.

18. Method for sealing a space closed by an outer skin in buildings, wherein a film comprising at least two layers, wherein one layer (layer 1) is humidity-variable and the quotient for water vapor diffusion resistance of the s_{d} value at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is greater than 3, and the other layer (layer 2) is essentially humidity-invariable and the quotient of the s_{d} value at 25% mean relative air humidity (according to DIN EN ISO 12572:2001 condition A/Dry Cup) to the s_{d} value at 71.5% mean relative air humidity (according to DIN EN ISO 12572:2001 condition C/Wet Cup) is less than 1.5, wherein the film is arranged such that layer 1 is aligned with the outer skin.

19. Method according to claim 17 or 18, wherein the film and/or the outer skin are defined as in one of claims 3 to 16.

20. System, comprising a film as defined in one of claims 1 to 6 or 8 to 14, and an outer skin, as defined in one of claim 1, 7, 15 or 16.

21. Vapor barrier, comprising at least two layers, of which one layer (layer 1) is humidity-variable and the quotient for the water vapor diffusion resistance of the s_{d} value at 25% mean relative air humidity to the s_{d} value at 71.5% mean relative air humidity is greater than 3, and the other layer (layer 2) is essentially humidity-independent and the quotient for the water vapor diffusion resistance of the s_{d} value at 25% mean relative air humidity to the s_{d} value at 71.5% mean relative air humidity is less than 1.5.

22. Vapor barrier according to claim 21, wherein layer 1 and layer 2 together have a thickness in the range of 20 μm to 550 μm, preferably between 75 μm and 550 μm.

23. Vapor barrier according to claim 21 or 22, wherein layer 1 has a thickness in the range of 10 μm to 200 μm, preferably between 50 μm and 200 μm.

24. Vapor barrier according to claims 21 to 23, wherein layer 2 has a thickness in the range of 10 μm to 350 μm, preferably between 25 μm and 350 μm.

25. Vapor barrier according to one of claims 21 to 24, wherein the material for layer 1 contains polyamide and/or ionomers.

26. Vapor barrier according to one of claims 21 to 25, wherein the material for layer 2 is selected from the group consisting of polyester, thermoplastic ether-ester copolymers (TPEE), polyolefins, polyethylenes, high density polyethylene (HDPE), polypropylene (PP), ethylene vinyl acetate (EVA), polylactides, starch-based polymers, polyacrylates, thermoplastic polyurethanes (TPU), and combinations thereof.

27. Vapor barrier according to one of claims 21 to 26, wherein for layer 1 the quotient for the water vapor diffusion resistance of the s_{d} value at 25% mean relative air humidity to the s_{d} value at 71.5% mean relative air humidity is greater than 4, preferably greater than 5.

28. Vapor barrier according to one of claims 21 to 27, wherein layer 2 at 71.5% mean relative humidity has an s_{d} value in the range of 1 m to 20 m, preferably of 1 m to 15 m.

29. Vapor barrier according to one of claims 21 to 28, wherein layer 2 is formed as a foil or a film.

30. Vapor barrier according to one of claims 21 to 29, wherein layers 1 and 2 are joined by bonding with adhesive, lamination, calendering or by coating one layer on the other.

31. Vapor barrier according to one of claims 21 to 29, wherein layers 1 and 2 are prepared as a multilayer film.

32. Vapor barrier according to one of claims 21 to 31, comprising at least one further layer, in particular for increasing the mechanical strength and/or water storage.

33. Vapor barrier according to one of claims 21 to 32, wherein its total thickness lies in the range of 20 μm to 700 μm, preferably of 60 μm to 600 μm.

34. Use of a vapor barrier according to one of claims 21 to 33 for the sealing of building envelopes.

35. System comprising a vapor barrier according to one of claims 21 to 33 and a component to be sealed.
